(19) United States
(12) Patent Application Publication
(10) Pub. No.: US 2017/0116046 A1
(43) Pub. Date: Apr. 27, 2017

(54) Method, Device for Setting System Data and Terminal

(71) Applicant: Yulong Computer Telecommunication Scientific (Shenzhen) Co., Ltd., Shenzhen (CN)

(72) Inventor: Jingen Sheng, Shenzhen (CN)

(21) Appl. No.: 15/397,233

(22) Filed: Jan. 3, 2017

Related U.S. Application Data
(63) Continuation-in-part of application No. PCT/CN2015/072019, filed on Jan. 30, 2015.

(30) Foreign Application Priority Data
Jan. 14, 2015 (CN) 201510018550.0

(51) Int. Cl. G06F 9/52

(52) U.S. Cl. CPC G06F 9/52

(57) ABSTRACT

Methods and devices for setting system data and terminals are provided. The method includes: when one of a plurality of systems receives a setting command, determining whether the setting command is a command associated with specified data in the given system, and if not, namely, the setting command is associated with common data in the given system and in other systems, then setting the common data in the given system and the other systems according to the setting command, the other systems being at least one system in the plurality of systems other than the given system. The methods, devices and terminals enable a user to perform a special setting of the specific data in different systems, and address the problem in which a common setting item (common data) cannot be completely synchronized, caused by the data in different systems being different.

### CROSS-REFERENCE TO RELATED APPLICATION(S)

This application is a continuation in part of international Patent Application PCT No. PCT/CN2015/072019 , filed on Jan. 30, 2015 , which claims priority to Chinese Patent Application No. 201510018550.0 , filed on Jan. 14, 2015 , the disclosures of both of which are herein incorporated by reference in their entireties.

### TECHNICAL FIELD

The present disclosure relates to the technical field of terminals, and more particularly, to a method for setting system data, a device for setting system data and a terminal.

### BACKGROUND

Currently, in some terminals, multiple systems are installed. However, when a user performs an ordinary setting of a certain system, for example, when performing a setting of password verification required for logging in the system, the setting is effective merely in this system, and cannot be synchronized in other systems. However, as far as common ordinary setting items of these different systems, preferences of the user are usually identical, and thus the user have to perform the setting of each of different systems.

On the other hand, as far as specific data in different systems, the user usually hopes to perform a special setting of the specific data in each system while not hoping to synchronize the setting of the specific data in the other systems.

Therefore, how to enable a user to perform a special setting of the specific data in different systems, and address the problem in which a common setting item, namely common data, cannot be completely synchronized, caused by the data in different systems being different, becomes urgent.

### SUMMARY

The present disclosure is addressed to the above-mentioned problem, and proposes a technical solution which enables a user to perform a special setting of the specific data in different systems, and addresses the problem in which a common setting item, namely common data, cannot be completely synchronized, caused by the data in different systems being different.

In view of this, according to one aspect of the present disclosure, a method for setting system data, used in a terminal in which a plurality of systems are installed, comprises: when one of the plurality of systems receives a setting command, determining whether the setting command is a command associated with specified data in the given system; and if not, namely, the setting command is associated with common data in the given system and in other systems, then setting the common data in the given system and the other systems according to the setting command, wherein the other systems are at least one system in the plurality of systems other than the given system.

In this technical solution, if one of the plurality of systems receives the setting command which is a command not associated with the specified data in the given system, the setting command is a command associated with ordinary settings in the given system or the common data in the plurality of systems, and the setting command may be synchronized in all the systems containing the common data, such that the user does not have to perform a setting of each of different systems, so as to address the problem in which a common setting item, namely common data, cannot be completely synchronized, caused by the data in different systems being different. For example, if a system A, a system B and a system C are installed in a terminal and the user performs a setting of size of fonts (common data in the three systems) in the system A, the terminal may determine that the setting command is an ordinary setting command and is not associated with specific data in the system A, when receiving the setting command. At this time, the terminal may synchronize the setting of the size of the fonts in the system B and system C, such that the size of the fonts in the three systems seems identical.

In the above-mentioned technical solution, preferably, if determining that the setting command is a command associated with the specified data in the given system, the specified data is set according to the setting command.

In this technical solution, if the setting command is a command associated with the specified data in the given system, the terminal may merely perform a special setting of the specific data (for example, unique data such as contact information, communication records and so on in the given system) in the given system, instead of synchronizing the setting command in the other systems, so as to ensure that the user may perform a special setting of the specific data in the given system and the different usage requirement of the user on different systems is met.

In the above-mentioned technical solution, preferably, determining whether the setting command is a command associated with the specified data in the given system specifically comprises: determining whether the setting command is a command associated with the specified data in the given system, according to identification information contained in the setting command.

In this technical solution, by means of the identification information contained in the setting command, a necessary basis is provided for accurately determining whether the setting command is a command associated with the specified data in the given system, and in turn, a basis is provided for determining whether to synchronize the setting command in the other systems. The identification information may be an identifier for identifying the common data and the specified data, or may be an identifier for identifying a system which the data belongs to, so as to indicate the type of the setting command.

In the above-mentioned technical solution, preferably, it is determined whether the given system has a security level lower than that of any other system in the plurality of systems, when performing a setting of each of the plurality of systems according to the setting command. And if so, the terminal user is prompted whether to perform a setting of the any other system according to the setting command.

In this technical solution, if the security of the given system is lower than that of the any other system when setting each system according to the setting command, it is required to give a prompting signal to the terminal user before the setting command is applied in the any other system, such that the user determines again whether to apply the setting command in the any other system, so as to prevent the security of a system having a higher security level from being affected due to applying the setting of a system having a lower security level in the system having a higher security level. For example, if a setting of the given system, with the result that a password is not required when accessing the system, is performed in the terminal, the terminal may determine that the setting command is an ordinary setting command not associated with the specified data in the given system, and synchronize the setting command in the other systems. However, if the security level of the any other system is higher than that of the given system, the terminal will give a prompting signal to the user, such that the user determines whether to apply the setting command in the any other system, so as to prevent the security of the any other system from being damaged.

In the above-mentioned technical solution, preferably, the specified data is updated according to the received updating command.

In this technical solution, the user may freely update the specified data in the given system and this is advantageous for improving the using experience of the user.

According to another aspect of the present disclosure, a device for setting system data, used in a terminal in which a plurality of systems are installed, comprises: a storage unit storing a plurality of computer-readable program codes; and a processor electrically connected to the storage unit and configured to execute the plurality of computer-readable program codes to: when one of the plurality of systems receives a setting command, determine whether the setting command is a command associated with specified data in the given system; and if not, namely, the setting command is associated with common data in the given system and in other systems, then set the common data in the given system and the other systems according to the setting command, wherein the other systems are at least one system in the plurality of systems other than the given system.

In this technical solution, if one of the plurality of systems receives the setting command which is a command not associated with the specified data in the given system, the setting command is a command associated with ordinary settings in the given system or the common data in the plurality of systems, and the setting command may be synchronized in all the systems containing the common data, such that the user does not have to perform a setting of each of different systems, so as to address the problem in which a common setting item, namely common data, cannot be completely synchronized, caused by the data in different systems being different. For example, if a system A, a system B and a system C are installed in a terminal and the user performs a setting of size of fonts (common data in the three systems) in the system A, the terminal may determine that the setting command is an ordinary setting command and is not associated with specific data in the system A, when receiving the setting command. At this time, the terminal may synchronize the setting of the size of the fonts in the system B and system C, such that the size of the fonts in the three systems seems identical.

In the above-mentioned technical solution, preferably, the processor is further configured to execute the plurality of computer-readable program codes to set the specified data according to the setting command, if determining that the setting command is a command associated with the specified data in the given system.

In this technical solution, if the setting command is a command associated with the specified data in the given system, the terminal may merely perform a special setting of the specific data (for example, unique data such as contact information, communication records and so on in the given system) in the given system, instead of synchronizing the setting command in the other systems, so as to ensure that the user may perform a special setting of the specific data in the given system and the different usage requirement of the user on different systems is met.

In the above-mentioned technical solution, preferably, determining whether the setting command is a command associated with the specified data in the given system, comprises: determining whether the setting command is a command associated with the specified data in the given system, according to identification information contained in the setting command.

In this technical solution, by means of the identification information contained in the setting command, a necessary basis is provided for accurately determining whether the setting command is a command associated with the specified data in the given system, and in turn, a basis is provided for determining whether to synchronize the setting command in the other systems. The identification information may be an identifier for identifying the common data and the specified data, or may be an identifier for identifying a system which the data belongs to, so as to indicate the type of the setting command.

In the above-mentioned technical solution, preferably, the processor is further configured to execute the plurality of computer-readable program codes to: determine whether the given system has a security level lower than that of any other system in the plurality of systems, when performing a setting of each of the plurality of systems according to the setting command; and if so, prompt the terminal user whether to perform a setting of the any other system according to the setting command.

In this technical solution, if the security of the given system is lower than that of the any other system when setting each system according to the setting command, it is required to give a prompting signal to the terminal user before the setting command is applied in the any other system, such that the user determines again whether to apply the setting command in the any other system, so as to prevent the security of a system having a higher security level from being affected due to applying the setting of a system having a lower security level in the system having a higher security level. For example, if a setting of the given system, with the result that a password is not required when accessing the system, is performed in the terminal, the terminal may determine that the setting command is an ordinary setting command not associated with the specified data in the given system, and synchronize the setting command in the other systems. However, if the security level of the any other system is higher than that of the given system, the terminal will give a prompting signal to the user, such that the user determines whether to apply the setting command in the any other system, so as to prevent the security of the any other system from being damaged.

In the above-mentioned technical solution, preferably, the processor is further configured to execute the plurality of computer-readable program codes to update the specified data according to the received updating command.

In this technical solution, the user may freely update the specified data in the given system and this is advantageous for improving the using experience of the user.

According to yet another aspect of the present disclosure, a terminal comprising the device for setting system data according to any one of the above-mentioned technical solutions is provided.

In this technical solution, the device for setting system data enables a user to perform a special setting of the specific data in different systems, and addresses the problem in which a common setting item and data cannot be completely synchronized, caused by the data in different systems being different.

The technical solution of the present disclosure enables a user to perform a special setting of the specific data in different systems, and addresses the problem in which a common setting item, namely common data, cannot be completely synchronized, caused by the data in different systems being different.

### BRIEF DESCRIPTION OF THE DRAWINGS

FIG. 1 shows a schematic flowchart diagram of a method for setting system data according to an implementation of the present disclosure;

FIG. 2 shows a schematic flowchart diagram of a method for setting system data according to another implementation of the present disclosure;

FIG. 3 shows a schematic structural diagram of a device for setting system data according to an implementation of the present disclosure;

FIG. 4 shows a schematic structural diagram of a terminal according to an implementation of the present disclosure.

FIG. 5 shows a schematic structural diagram of a device for setting system data according to an implementation of the present disclosure.

### DETAILED DESCRIPTION

The present disclosure is further described in detail hereinafter with reference to the accompanying drawings and implementations, in order to more fully understand the above-mentioned purposes, features and advantages of the present disclosure. It should be noted that, when not conflicting, the implementations of the present application and features in the implementations could be combined mutually.

A lot of details are set forth in the below description so as to fully understand the present disclosure, however, the present disclosure may also be implemented by adopting other implementations different from those as described herein, and therefore, the protection scope of the present disclosure is not limited by the implementations disclosed below.

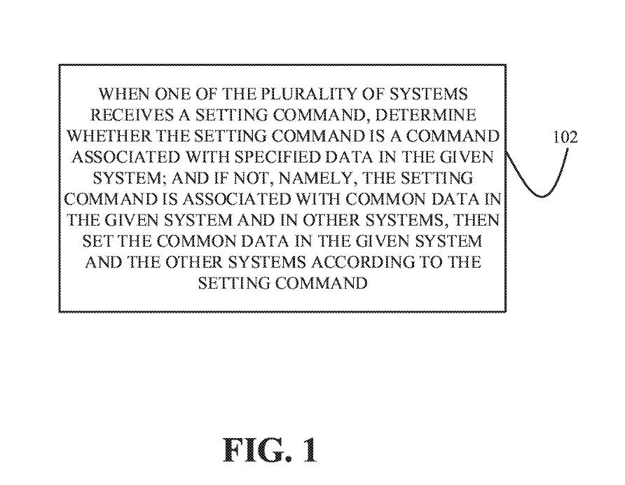

FIG. 1 shows a schematic flowchart diagram of a method for setting system data according to an implementation of the present disclosure.

As shown in FIG. 1, a method for setting system data according to an implementation of the present disclosure, comprises: a step 102 of, when one of a plurality of systems receives a setting command, determining whether the setting command is a command associated with specified data in the given system; and if not, namely, the setting command is associated with common data in the given system and in other systems, then setting the common data in the given system and the other systems according to the setting command, wherein the other systems are at least one system in the plurality of systems other than the given system.

In this technical solution, if one of the plurality of systems receives the setting command which is a command not associated with the specified data in the given system, the setting command is a command associated with ordinary settings in the given system or the common data in the plurality of systems, and the setting command may be synchronized in all the systems containing the common data, such that the user does not have to perform a setting of each of different systems, so as to address the problem in which a common setting item, namely common data, cannot be completely synchronized, caused by the data in different systems being different. For example, if a system A, a system B and a system C are installed in a terminal and the user performs a setting of size of fonts (common data in the three systems) in the system A, the terminal may determine that the setting command is an ordinary setting command and is not associated with specific data in the system A, when receiving the setting command. At this time, the terminal may synchronize the setting of the size of the fonts in the system B and system C, such that the size of the fonts in the three systems seems identical.

In the above-mentioned technical solution, preferably, if determining that the setting command is a command associated with the specified data in the given system, the specified data is set according to the setting command.

In this technical solution, if the setting command is a command associated with the specified data in the given system, the terminal may merely perform a special setting of the specific data (for example, unique data such as contact information, communication records and so on in the given system) in the given system, instead of synchronizing the setting command in the other systems, so as to ensure that the user may perform a special setting of the specific data in the given system and the different usage requirement of the user on different systems is met.

In the above-mentioned technical solution, preferably, determining whether the setting command is a command associated with the specified data in the given system specifically comprises: determining whether the setting command is a command associated with the specified data in the given system, according to identification information contained in the setting command.

In this technical solution, by means of the identification information contained in the setting command, a necessary basis is provided for accurately determining whether the setting command is a command associated with the specified data in the given system, and in turn, a basis is provided for determining whether to synchronize the setting command in the other systems. The identification information may be an identifier for identifying the common data and the specified data, or may be an identifier for identifying a system which the data belongs to, so as to indicate the type of the setting command.

In the above-mentioned technical solution, preferably, it is determined whether the given system has a security level lower than that of any other system in the plurality of systems, when performing a setting of each of the plurality of systems according to the setting command. And if so, the terminal user is prompted whether to perform a setting of the any other system according to the setting command.

In this technical solution, if the security of the given system is lower than that of the any other system when setting each system according to the setting command, it is required to give a prompting signal to the terminal user before the setting command is applied in the any other system, such that the user determines again whether to apply the setting command in the any other system, so as to prevent the security of a system having a higher security level from being affected due to applying the setting of a system having a lower security level in the system having a higher security level. For example, if a setting of the given system, with the result that a password is not required when accessing the system, is performed in the terminal, the terminal may determine that the setting command is an ordinary setting command not associated with the specified data in the given system, and synchronize the setting command in the other systems. However, if the security level of the any other system is higher than that of the given system, the terminal will give a prompting signal to the user, such that the user determines whether to apply the setting command in the any other system, so as to prevent the security of the any other system from being damaged.

In the above-mentioned technical solution, preferably, the specified data is updated according to the received updating command.

In this technical solution, the user may freely update the specified data in the given system and this is advantageous for improving the using experience of the user.

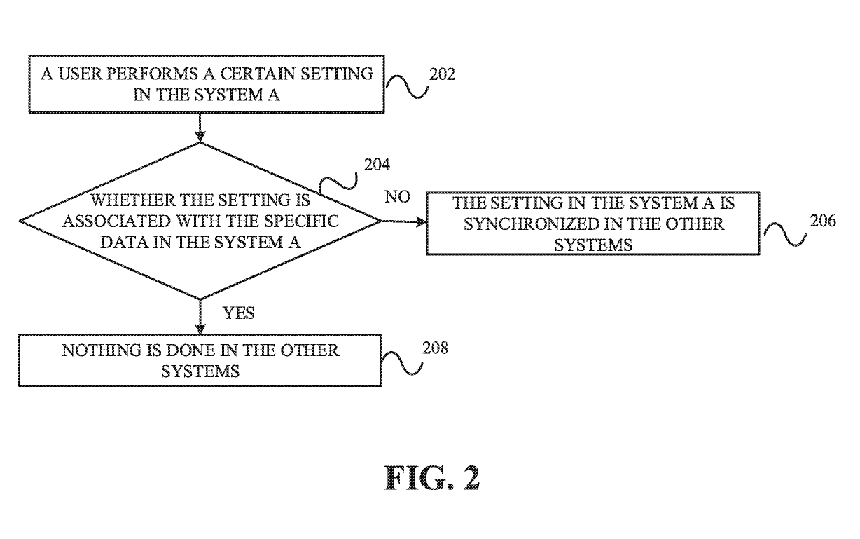

FIG. 2 shows a schematic flowchart diagram of a method for setting system data according to another implementation of the present disclosure.

As shown in FIG. 2, a method for setting system data according to another implementation of the present disclosure, comprises:

Step 202: A user performs a certain setting in the system A.

Step 204: Whether the setting is associated with the specific data (specified data) in the system A is determined; if so, Step 208 is performed; otherwise, Step 206 is performed.

Step 206: the setting in the system A is synchronized in the other systems.

Step 208: Nothing is done in the other systems.

For example, assuming that the system A (ordinary system) and the system B (secure system) are installed in the terminal, since secure contacts are all stored in the secure system and ordinary contacts are stored in the ordinary system without sharing with each other, the secure contacts are the special data in the secure system and the ordinary contacts are the special data in the ordinary system. When the user adds an ordinary contact in a white list in the ordinary system, this operation is associated with the special data in the secure system, and thus the white list data in the ordinary system is changed after adding, while the white list data in the secure system remains the same. However, if the user adjusts a non-disturbing period (in this period, only calls or messages from the contacts in the white list are allowed to be received) in the ordinary system from 23:00-08:00 to 22:00-7:30, a non-disturbing period in the secure system should also be adjusted accordingly.

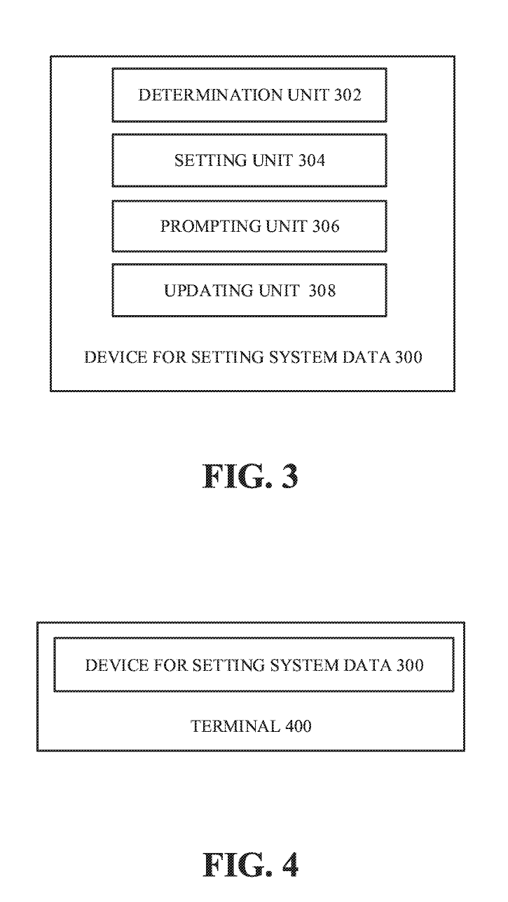

FIG. 3 shows a schematic structural diagram of a device for setting system data according to an implementation of the present disclosure.

As shown in FIG. 3, a device 300 for setting system data according to an implementation of the present disclosure, comprises: a determination unit 302 for, when one of a plurality of systems receives a setting command, determining whether the setting command is a command associated with specified data in the given system; and a setting unit 304 for, if not, namely, the setting command is associated with common data in the given system and in other systems, then setting the common data in the given system and the other systems according to the setting command, wherein the other systems are at least one system in the plurality of systems other than the given system.

In this technical solution, if one of the plurality of systems receives the setting command which is a command not associated with the specified data in the given system, the setting command is a command associated with ordinary settings in the given system or the common data in the plurality of systems, and the setting command may be synchronized in all the systems containing the common data, such that the user does not have to perform a setting of each of different systems, so as to address the problem in which a common setting item, namely common data, cannot be completely synchronized, caused by the data in different systems being different. For example, if a system A, a system B and a system C are installed in a terminal and the user performs a setting of size of fonts (common data in the three systems) in the system A, the terminal may determine that the setting command is an ordinary setting command and is not associated with specific data in the system A, when receiving the setting command. At this time, the terminal may synchronize the setting of the size of the fonts in the system B and system C, such that the size of the fonts in the three systems seems identical.

In the above-mentioned technical solution, preferably, the setting unit 304 is further for setting the specified data according to the setting command, if determining that the setting command is a command associated with the specified data in the given system.

In this technical solution, if the setting command is a command associated with the specified data in the given system, the terminal may merely perform a special setting of the specific data (for example, unique data such as contact information, communication records and so on in the given system) in the given system, instead of synchronizing the setting command in the other systems, so as to ensure that the user may perform a special setting of the specific data in the given system and the different usage requirement of the user on different systems is met.

In the above-mentioned technical solution, preferably, the determination unit 302 is specifically for determining whether the setting command is a command associated with the specified data in the given system, according to identification information contained in the setting command.

In this technical solution, by means of the identification information contained in the setting command, a necessary basis is provided for accurately determining whether the setting command is a command associated with the specified data in the given system, and in turn, a basis is provided for determining whether to synchronize the setting command in the other systems. The identification information may be an identifier for identifying the common data and the specified data, or may be an identifier for identifying a system which the data belongs to, so as to indicate the type of the setting command.

In the above-mentioned technical solution, preferably, the determination unit 302 is further for determining whether the given system has a security level lower than that of any other system in the plurality of systems, when performing a setting of each of the plurality of systems according to the setting command; a prompting unit 306 is for if so, prompting the terminal user whether to perform a setting of the any other system according to the setting command.

In this technical solution, if the security of the given system is lower than that of the any other system when setting each system according to the setting command, it is required to give a prompting signal to the terminal user before the setting command is applied in the any other system, such that the user determines again whether to apply the setting command in the any other system, so as to prevent the security of a system having a higher security level from being affected due to applying the setting of a system having a lower security level in the system having a higher security level. For example, if a setting of the given system, with the result that a password is not required when accessing the system, is performed in the terminal, the terminal may determine that the setting command is an ordinary setting command not associated with the specified data in the given system, and synchronize the setting command in the other systems. However, if the security level of the any other system is higher than that of the given system, the terminal will give a prompting signal to the user, such that the user determines whether to apply the setting command in the any other system, so as to prevent the security of the any other system from being damaged.

In the above-mentioned technical solution, preferably, an updating unit 308 is for updating the specified data according to the received updating command.

In this technical solution, the user may freely update the specified data in the given system and this is advantageous for improving the using experience of the user.

FIG. 4 shows a schematic structural diagram of a terminal according to an implementation of the present disclosure.

As shown in FIG. 4, a terminal 400 according to an implementation of the present disclosure comprises: the device 300 for setting system data according to any one of the above-mentioned technical solutions.

In this technical solution, the device 300 for setting system data enables a user to perform a special setting of the specific data in different systems, and addresses the problem in which a common setting item and data cannot be completely synchronized, caused by the data in different systems being different.

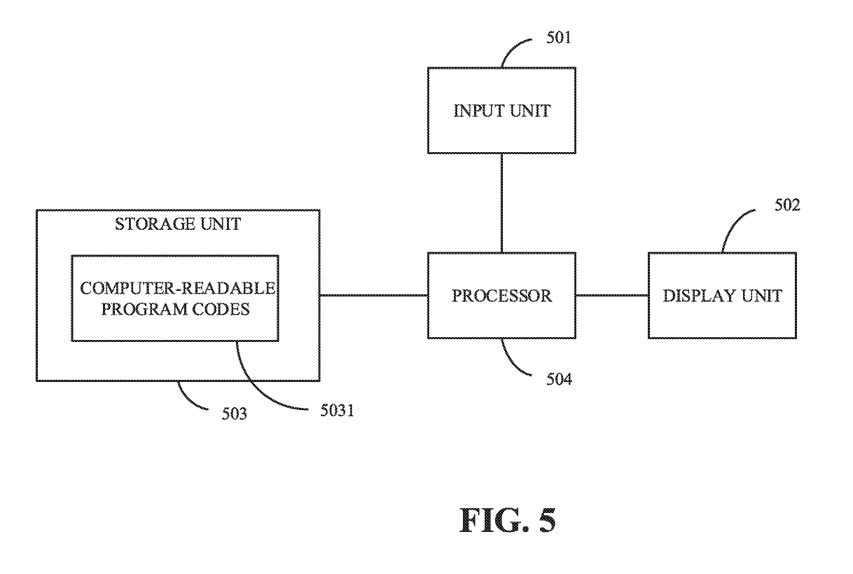

FIG. 5 shows a schematic structural diagram of a device for setting system data according to an implementation of the present disclosure.

As shown in FIG. 10, a device for setting system data according to an implementation of the present disclosure can include but not limited to an input unit 501, a display unit 502, a storage unit 503, and a processor 504. The input unit 501, the display unit 502, and the storage unit 503 are electrically connected to the processor 504.

The input unit 501 is configured to input information to the device for setting system data, such as letters. The input unit 501 may be but not limited to a physical keyboard, a touchscreen, or a combination of the physical keyboard and the touchscreen.

The display unit 502 is configured to display visual information, such as text, image. The display unit 502 may be an LED display screen.

The storage unit 503 is configured to store a plurality of computer-readable program codes 5031. The storage unit 503 can be a read only memory (ROM), a random access memory (RAM), a U-disk, a removable hard disk, etc.

The processor 504 can include multiple cores for multi-thread or parallel processing.

In this implementation, the processor 504 is configured to execute the plurality of computer-readable program codes 5031 to, when one of the plurality of systems receives a setting command, determine whether the setting command is a command associated with specified data in the given system; and if not, namely, the setting command is associated with common data in the given system and in other systems, then set the common data in the given system and the other systems according to the setting command, wherein the other systems are at least one system in the plurality of systems other than the given system.

In this implementation, the processor 504 is further configured to execute the plurality of computer-readable program codes to set the specified data according to the setting command, if determining that the setting command is a command associated with the specified data in the given system.

In this implementation, determining whether the setting command is a command associated with the specified data in the given system, comprises: determining whether the setting command is a command associated with the specified data in the given system, according to identification information contained in the setting command.

In this implementation, the processor 504 is further configured to execute the plurality of computer-readable program codes to determine whether the given system has a security level lower than that of any other system in the plurality of systems, when performing a setting of each of the plurality of systems according to the setting command; and if so, prompt the terminal user whether to perform a setting of the any other system according to the setting command.

The technical solution of the present disclosure is described in detail in conjunction with the accompanying drawings, hereinbefore. The technical solution of the present disclosure enables a user to perform a special setting of the specific data in different systems, and addresses the problem in which a common setting item and data cannot be completely synchronized, caused by the data in different systems being different.

The foregoing is merely the preferred implementations of the present disclosure, and is not intended to limit the present disclosure. For persons skilled in the art, the present disclosure could have various modifications and variations. Any amendments, equivalents, or improvements and so on within the spirit and principle of the present disclosure should be included within the protection scope of the present disclosure.

What is claimed is:

1. A method for setting system data, used in a terminal, wherein a plurality of systems are installed in the terminal, comprising:
when one of the plurality of systems receives a setting command, determining whether the setting command is a command associated with specified data in the given system; and
in response to a determination that the setting command is not a command associated with specified data in the given system and based on a determination that the setting command is associated with common data in the given system and in other systems, setting the common data in the given system and the other systems according to the setting command, wherein the other systems are at least one system in the plurality of systems other than the given system.

2. The method of claim 1, comprising:
setting the specified data according to the setting command, when the setting command is determined as a command associated with the specified data in the given system.

3. The method of claim 1, wherein determining whether the setting command is a command associated with the specified data in the given system comprises:
determining whether the setting command is a command associated with the specified data in the given system, according to identification information contained in the setting command.

4. The method of claim 1, comprising:
determining whether the given system has a security level lower than that of any other system in the plurality of systems, when performing a setting of each of the plurality of systems according to the setting command; and
when the given system has a security level lower than that of the other system in the plurality of systems, prompting a terminal user whether to perform a setting of the any other system according to the setting command.

5. The method of claim 1, comprising:
updating the specified data according to the received setting command.

6. The method of claim 2, comprising:
updating the specified data according to the received setting command.

7. The method of claim 3, comprising:
updating the specified data according to the received setting command.

8. The method of claim 4, comprising:
updating the specified data according to the received setting command.

9. A device for setting system data, used in a terminal, wherein a plurality of systems are installed in the terminal, and the device comprises:
a storage unit storing a plurality of computer-readable program codes; and
a processor electrically connected to the storage unit and configured to execute the plurality of computer-readable program codes to:
when one of the plurality of systems receives a setting command, determine whether the setting command is a command associated with specified data in the given system; and
in response to a determination that the setting command is not a command associated with specified data in the given system and based on a determination that the setting command is associated with common data in the given system and in other systems, set the common data in the given system and the other systems according to the setting command, wherein the other systems are at least one system in the plurality of systems other than the given system.

10. The device of claim 9, wherein the processor is further configured to execute the plurality of computer-readable program codes to set the specified data according to the setting command, when the setting command is determined as a command associated with the specified data in the given system.

11. The device of claim 9, wherein determining whether the setting command is a command associated with the specified data in the given system, comprises:
determining whether the setting command is a command associated with the specified data in the given system, according to identification information contained in the setting command.

12. The device of claim 9, wherein the processor is further configured to execute the plurality of computer-readable program codes to:
determine whether the given system has a security level lower than that of any other system in the plurality of systems, when performing a setting of each of the plurality of systems according to the setting command; and
when the given system has a security level lower than that of the other system in the plurality of systems, prompt a terminal user whether to perform a setting of the any other system according to the setting command.

13. The device of claim 9, wherein the processor is further configured to execute the plurality of computer-readable program codes to update the specified data according to the received setting command.

14. The device of claim 10, wherein the processor is further configured to execute the plurality of computer-readable program codes to update the specified data according to the received setting command.

15. The device of claim 11, wherein the processor is further configured to execute the plurality of computer-readable program codes to update the specified data according to the received setting command.

16. A terminal comprising a device for setting system data, wherein a plurality of systems are installed in the terminal, and the device comprises:
a storage unit storing a plurality of computer-readable program codes; and
a processor electrically connected to the storage unit and configured to execute the plurality of computer-readable program codes to:
when one of the plurality of systems receives a setting command, determine whether the setting command is a command associated with specified data in the given system; and
in response to a determination that the setting command is not a command associated with specified data in the given system and based on a determination that the setting command is associated with common data in the given system and in other systems, set the common data in the given system and the other systems according to the setting command, wherein the other systems are at least one system in the plurality of systems other than the given system.

17. The terminal of claim 16, wherein the processor is further configured to execute the plurality of computer-readable program codes to set the specified data according to the setting command, when the setting command is determined as a command associated with the specified data in the given system.

18. The terminal of claim 16, wherein determining whether the setting command is a command associated with the specified data in the given system, comprises:
determining whether the setting command is a command associated with the specified data in the given system, according to identification information contained in the setting command.

19. The terminal of claim 16, wherein the processor is further configured to execute the plurality of computer-readable program codes to:
determine whether the given system has a security level lower than that of any other system in the plurality of systems, when performing a setting of each of the plurality of systems according to the setting command; and
when the given system has a security level lower than that of the other system in the plurality of systems, prompt a terminal user whether to perform a setting of the any other system according to the setting command.

20. The terminal of claim 16, wherein the processor is further configured to execute the plurality of computer-readable program codes to update the specified data according to the received setting command.
